(19) United States
(12) Patent Application Publication
(10) Pub. No.: US 2017/0212646 A1
(43) Pub. Date: Jul. 27, 2017

(54) CLIENT INTERFACE LOADING CONTROL METHOD AND APPARATUS

(71) Applicant: GUANGZHOU UCWEB COMPUTER TECHNOLOGY CO., LTD., Guangzhou (CN)

(72) Inventors: Liang RAO, Guangzhou (CN); Jianfeng WU, Guangzhou (CN); Sensen LIU, Guangzhou (CN)

(21) Appl. No.: 15/411,122

(22) Filed: Jan. 20, 2017

(30) Foreign Application Priority Data
Jan. 26, 2016 (CN) 201610056927.6

(51) Int. Cl. G06F 3/0482; G06F 9/44

(52) U.S. Cl. CPC G06F 3/0482; G06F 9/4443; G06F 3/0488

(57) ABSTRACT

In accordance with various embodiments of the disclosed subject matter, a client interface loading; control method, and a related apparatus are provided, In some embodiments, the method comprises: when the client starts, displaying an information channel selection interface; receiving a user click operation to the information channel selection interface, and determining a preferred information channel corresponding to the user click operation; adjusting a display order of a plurality of channel labels according to the preferred information channel, such that a channel label corresponding to the preferred information channel is listed before other channel labels; and when the client starts after the display order is adjusted, loading a client interface of the client according to the adjusted display order of the plurality of channel labels.

### CROSS-REFERENCES TO RELATED APPLICATIONS

This application claims the priority of Chinese Patent Application No. 201610056927.6, filed on Jan. 26, 2016, the entire content of which is incorporated herein by reference.

### FIELD OF THE DISCLOSURE

The present disclosure generally relates to the field of human computer interaction technology and, more particularly, relates to a client interface loading control method, and a related apparatus.

### BACKGROUND

With rapid development of electronics and communications industry, obtaining information including news, common knowledges, and other types of information by using electronic devices (e.g., mobile phones, tablet PCs, etc.) has become a popular trend. In the related art users can obtain and read all kinds of information by using various electronic devices through software clients that have information reading (information display) function. Generally, different users may prefer different types of information. For example, some users may prefer reading sports information, some other users may be more concerned about the financial information, and sonic other users may be mostly interested in entertainment information, etc. In view of this, the clients having the information reading function can classify the information, and display different types of information in different channel pages, which can facilitate users to focus more on reading the information they are interested in. In order to meet the different reading needs of different users, the clients having the'information reading function can set up multiple channel pages. Each channel page corresponds to a channel label,.The multiple channel pages can be arranged on a channel label bar in accordance with system default order. When a user clicks a channel label, the current page can be switched to the corresponding channel page.

However, in practical applications, because the screen sizes of various electronic equipment for running the reading software are all limited, it may not be possible to display all channel labels at the same time. Therefore, users usually need to manually change page or drag the channel label bar to display different channel labels. If a channel label corresponding to a user's interest is in a rear position in a sorted default order of the multiple channel labels, the user has to change the page or drag the channel label bar to find the channel label each time when starting the reading software.

As an example, a browser having a reading function is shown in FIG. 1. It is assumed that information-of-interest to a certain user is automobile type information As shown in FIG. 1, the information display interface obtained directly after the browser being started is a channel page 101 with the first channel label in the channel label bar as “ [symbol] (Sports),” Multiple channel labels of “ [symbol] (Sports),” “ [symbol] (Video),” “ [symbol] (Finance),” and so on, are displayed in the channel label bar. However, there may be no “ [symbol] (Automobile)” label in the channel page 101. The user needs to drag the channel label bar until the “ [symbol] (Automobile)” label label is displayed, as shown on page 102. The user can then click the “ [symbol] (Automobile)” label to switch the display interface to the automobile channel page to read the automobile class information. It can be seen that, the existing interface loading method of the information-reading-type client is disadvantageous for users to quickly find information display pages that are of interest to the users, resulting in wasting users' time and reducing user experience favorability.

The disclosed method and apparatus are directed to solve one or more problems set forth above and other problems.

### BRIEF SUMMARY OF THE DISCLOSURE

In accordance with some embodiments of the disclosed subject matter, a client interface loading control method, and a related apparatus are provided.

An aspect of the present disclosure provides a method for controlling an interface loading of a client, comprising: when the client starts, displaying an information channel selection interface; receiving a user click operation to the information channel selection interface, and determining a preferred information channel corresponding to the user click operation; adjusting a display order of a plurality of channel labels according to the preferred information channel, such that a channel label corresponding to the preferred information channel is listed before other channel labels; and when the client starts after the display order is adjusted, loading a client interface of the client according to the adjusted display order of the plurality of channel labels.

In some embodiments, the information channel selection interface is displayed in a form of bubbles; and each bubble of the information channel selection interface corresponds to at least one information channel.

In some embodiments, the method further comprises: if a user click operation of the information channel selection interface is not received within a predetermined time, setting at least one preset information channel as the preferred information channel.

In some embodiments, the method further comprises: displaying a page switching control in the information channel selection interface.

In some embodiments, the method further comprises: after determining the preferred information channel, uploading the preferred information channel to a server.

In some embodiments, the preferred information channel is uploaded in association with a user ID of the client.

In some embodiments, the method further comprises: receiving recommendation information determined by the server according to the preferred information channel; and loading and displaying the recommendation information on a channel page corresponding to a recommended channel label.

In some embodiments, the at least one preset information channel is determined by the client based on an information channel accessing history of the client.

In some embodiments, the at least one preset information channel is determined by a serve based on statistic information channel accessing data of a plurality of users.

In some embodiments, the method further comprises: determining a first preferred information channel corresponding to a first user click operation to the information channel selection interface; determining a second preferred information channel corresponding to a second ser click operation to the information channel selection interface; and adjusting a display order of a plurality of channel labels, such that a first channel label corresponding to the first preferred information channel and a second channel label corresponding to the second preferred information channel are listed before other channel labels.

In some embodiments, adjusting the display order of the plurality of channel labels includes ranking the first channel label and the second channel label based on a clicking order of the first user click operation and the second user click operation.

In some embodiments, adjusting the display order of the plurality of channel labels includes ranking the first channel label and the second channel label based on a system default channel label order.

Another aspect of the present disclosure provides an apparatus for controlling an interface loading of a client, comprising: a selection interface control unit configured for displaying an information channel selection interface when the client starts; a preferred channel determining unit configured for receiving a user click operation to the information channel selection interface, and determining a preferred information channel corresponding to the user click operation; channel order adjusting unit configured for adjusting a display order of a plurality of channel labels according to the preferred information channel, such that a channel label corresponding to the preferred information channel is listed before other channel labels; and an interface loading unit configured for loading a client interface of the client according to the adjusted display order of the plurality of channel labels when the client starts after the display order is adjusted.

In some embodiments, the selection interface control unit is further configured for: displaying the information channel selection interface in a form of bubbles; wherein each bubble of the information channel selection interface corresponds to at least one information channel.

In some embodiments, the apparatus further comprises: a preferred channel back-up unit configured for setting at least one preset information channel as the preferred information channel if a user click operation of the information channel selection interface is not received within a predetermined time.

In some embodiments, the selection interface control unit is further configured for: displaying a page switching control in the information channel selection interface.

In some embodiments, the apparatus further comprises: a preferred channel uploading unit configured for uploading the preferred information channel to a server after determining the preferred information channel.

In some embodiments, the apparatus further comprises: a recommended channel updating unit configured for: receiving recommendation information determined by the server according to the preferred information channel; and loading and displaying the recommendation information on a channel page corresponding to a recommended channel label.

In some embodiments, the at least one preset information channel is determined by the client based on an information channel accessing history of the client.

In some embodiments, the at least one preset information channel is determined by a serve based on statistic information channel accessing data of a plurality of users.

Other aspects of the present disclosure can be understood by those skilled in the art in light of the description, the claims, and the drawings of the present disclosure.

### BRIEF DESCRIPTION OF THE DRAWINGS

Various objectives, features, and advantages of the disclosed subject matter can be more fully appreciated with reference to the detailed description of the disclosed subject matter when considered in connection with the following drawings, in which like reference numerals identify like elements. It should be noted that the following drawings are merely examples for illustrative purposes according to various disclosed embodiments and are not intended to limit the scope of the present disclosure.

FIG. 1 illustrates an information display interface of an information reading type client and a switching operation of the information display interface in related art;

FIG. 2 illustrates a flowchart of an exemplary client interface loading control method in accordance with some embodiments of the disclosed subject matter;

FIG. 3 illustrates a schematic diagram of an exemplary client interface obtained by the client interface loading control method in accordance with some embodiments of the disclosed subject matter;

FIG. 4 illustrates a schematic diagram of an information channel selection interface in accordance with some embodiments of the disclosed subject matter;

FIG. 5 illustrates a flowchart of another exemplary client interface loading corm method in accordance with some other embodiments of the disclosed subject matter;

FIG. 6 illustrates a block structural diagram of an exemplary configuration of a client interface loading control apparatus in accordance with some embodiments of the disclosed subject matter;

FIG. 7 illustrates a block structural diagram of another exemplary configuration of a client interface loading control apparatus in accordance with some other embodiments of the disclosed subject matter; and

FIG. 8 illustrates a schematic hardware diagram of an exemplary client interface loading control apparatus in accordance with some other embodiments of the disclosed subject matter.

### DETAILED DESCRIPTION

Reference input now be made in detail to exemplary embodiments of the invention, which are illustrated in the accompanying drawings. Hereinafter, embodiments consistent with the disclosure will be described with reference to the drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

In accordance with various embodiments, the present disclosure provides a client interface loading control method, and a related apparatus.

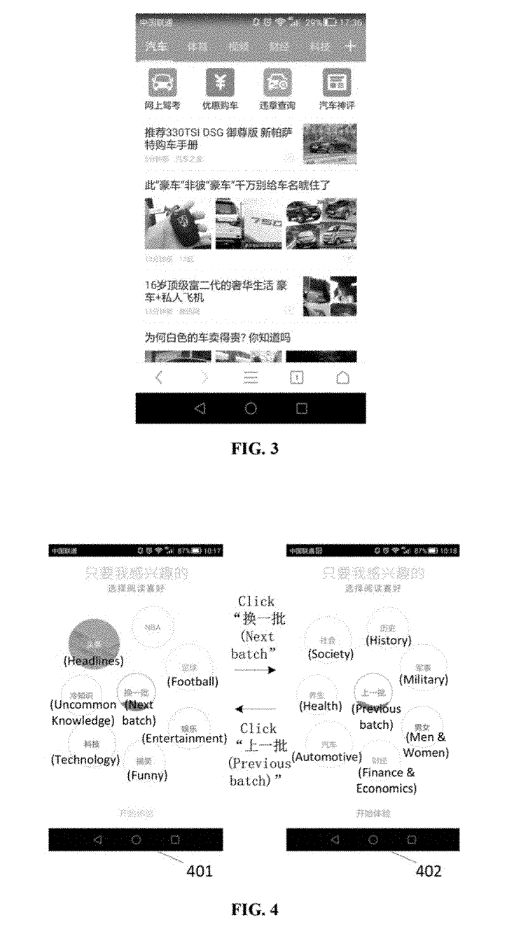

Referring to FIG. 2, a flowchart of an exemplary client interface loading control method is shown in accordance with some embodiments of the disclosed subject matter.

The disclosed method can be applied to a client having an information reading (information display) function, such as a browser client, various news website clients, etc. As illustrated, the disclosed method can include the following steps.

At step S11, when the client starts, an information channel selection interface can be displayed.

At step S12, a user click operation to the information channel selection interface can be received, and a preferred information channel corresponding to the user click operation can be determined.

In some embodiments, when the client starts, an information channel selection interface can be provided to realize the human-computer interaction with the user to obtain the information channel of interest of the user, which is the preferred information channel. Specifically, a touch control may be provided for each information channel. Multiple touch controls may be displayed side by side in the information channel selection interface to received user click operations. If one touch control receives a user click operation, the corresponding information channel can be selected as a preferred information channel. In addition, some prompt information such as “choose you like,” “customize your own content,” and other tips can also be displayed in the information channel selection interface to enable the users to understand the functions and operations of the information channel selection interface.

At step S13, the display order of the multiple channel labels can be adjusted according to the preferred information channel, so that the channel label corresponding to the preferred information channel can be listed before other channel labels.

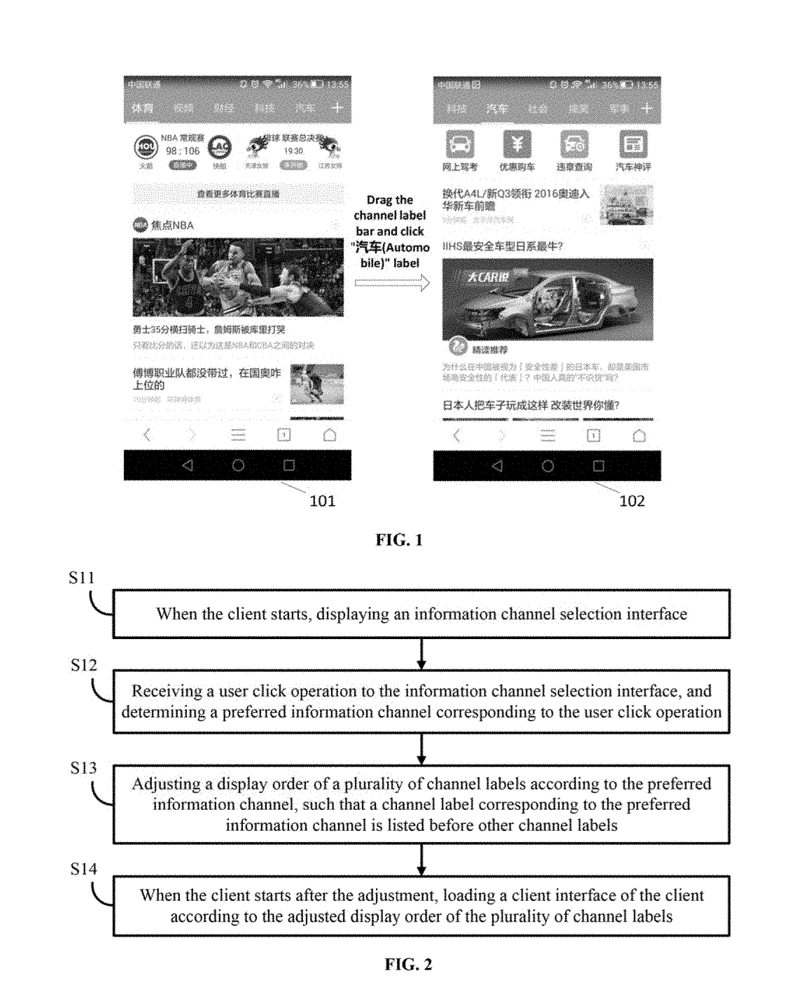

Taking the interface shown in FIG. 1 as an example, in accordance with the system default order, the multiple channel labels can be listed as the following order: [symbol] (Sports)— [symbol] (Video)— [symbol] (Finance)— [symbol] (Technology)— [symbol] (Automotive)— [symbol] (Society)— [symbol] (Funny)— [symbol] (Military)—etc. By using the step S12, a preferred information channel of the current user can be determined corresponding to the channel label of “ [symbol] (Automotive)”, then the channel label of “ [symbol] (Automotive)” can be adjusted to the front of the display order of the multiple channel labels, and the other channel labels can remain in the system default order. That is, the adjusted display order of the multiple channel labels can be the following: [symbol] (Automotive)— [symbol] (Sports)— [symbol] (Video)— [symbol] (Finance)— [symbol] (Technology)— [symbol] (Society)— [symbol] (Funny)— [symbol] (Military)—etc.

In addition, it can be assumed that more than one preferred information channels can be determined in step S12. In one embodiment, the relative order of the more than one preferred information channels may be determined in accordance with the user's click order to the touch controls of the corresponding information channels. In another embodiment, the relative order of the more than one preferred information channels may be determined based on the system default order of the more than one preferred information channels.

Still taking the interface shown in FIG. 1 as an example, it is assumed that the step S12 determines that the preferred information channels includes “ [symbol] (Automotive)” and “ [symbol] (Finance).” Further, a user click operation of the touch control corresponding to the information channels “ [symbol] (Automotive)” is received before a user click operation of the touch control corresponding to the information channels “ [symbol] (Finance).” Based on the user click order, the display order of the multiple channel labels can be adjusted as the following: [symbol] (Automotive)— [symbol] (Finance)— [symbol] (Sports)— [symbol] (Video)— [symbol] (Technology)— [symbol] (Society)— [symbol] (Funny)— [symbol] (Military)—etc. Based on the system default order of the two information channels “ [symbol] (Automotive)” and “ [symbol] (Finance),” the display order of the multiple channel labels can be adjusted as the following: [symbol] (Finance)— [symbol] (Automotive)— [symbol] (Sports)— [symbol] (Video)— [symbol] (Technology)— [symbol] (Society)— [symbol] (Funny)— [symbol] (Military)—etc.

At step S14, when the client starts after the adjustment, the client interface can be loaded according to the adjusted display order of the multiple channel labels.

When the adjusted display order of the multiple channel labels is the following: [symbol] (Automotive)— [symbol] (Sports)— [symbol] (Video)— [symbol] (Finance)— [symbol] (Technology)— [symbol] (Society)— [symbol] (Funny)— [symbol] (Military)—etc., the client interface can be loaded based on the above adjusted display order of the multiple channel labels, which is shown in FIG. 3.

Comparing to the client interface shown in FIG. 1, the channel label “ [symbol] (Automotive)” can be displayed in the front of the channel label bar in the client interface shown in FIG. 3. Further, the client interface can directly display the channel page of “ [symbol] (Automotive)” after the client is started. Therefore, the user being mostly concerned about the automotive type information can directly see a page of automotive type information without any selection or clicking operation after opening or starting the client.

According to the above technical solution, the disclosed client interface loading control method can display an information channel selection interface to the user when the client starts, and prompt the user to perform click operations to select one or more information channels of interest. The information channels corresponding to user click operations can be determined as the preferred information channels. A display order of channel labels can be adjusted based on the preferred information channels, so that the channel labels corresponding to the preferred information channels can be listed and displayed before other channel labels. As such, after the adjustment of the display order of the channel labels, the client interface can be loaded to display the channel pages of the preferred information channels in priority in the display interface.

Comparing to the related art that the channel labels and the channel pages are listed based on a system default order, the disclosed client interface loading control method can actively guide the user to select the channels of interest, and can move the selected channel forward and display the selected channel in priority. As such, after opening the client, the user can directly see the channel of interest without any manual operations such as dragging and clicking to switch a page of interest to the current page. Therefore, the disclosed client interface loading control method can reduce the manual operation time, and improve the user's experience favorability.

Further, the steps S11 to S13 may be executed only when the client is started for the first time, and when the client is started again, the interface loading can be performed directly based on the adjusted display order of the multiple channel labels determined in step S13.

In some embodiments, the display information channel selection interface described in step S11 may be, in particular, displayed in a form of bubbles.

Multiple touch controls of the it channels can be displayed side by side in the information channel selection interface in the form of bubbles. Each of the bubble-type touch controls can correspond to at least one information channel. Referring to FIG. 4, a schematic diagram of an information channel selection interface is shown in accordance with some embodiments of the disclosed subject matter. As illustrated, the information channel selection interface can display multiple bubble-type touch controls corresponding to “ [symbol] (Technology),” “ [symbol] (Entertainment),” and other channels.

Further, a page switching control can be displayed in the information channel selection interface. When there are too many information channels to be displayed at the same time in one page, the information channels can be divided into two or more batches to be display in two or more pages. A page switching control can be displayed in each page to achieve a switch between different pages.

As shown in FIG. 4, the information channels of the client can be displayed in two pages labeled as 401 and 402. Page switching controls “ [symbol] (Next batch)” and “ [symbol] (Previous batch)” can be displayed respectively in the two pages. When a user clicks the page switching control “ [symbol] (Nest batch)” in page 401, the information channel selection interface may be switched to page 402. Accordingly, when the user clicks the page switching control “ [symbol] [symbol] (Previous batch)” in page 402, the information channel selection interface may be switched back to page 402.

In some embodiments, the disclosed client interface loading control method can further include the following step.

If a user click operation of the information channel selection interface is not received within a predetermined time, one or more preset information channels can be set as the preferred information channels.

In some scenarios, because a user is not interested in a particular type of information or due to other reasons, the user may not make a selection when the information channel selection interface is displayed on the client. That is, if there is no click operation of the information channel selection interface, the preferred information channel cannot be determined according to the user's selection. In such scenarios, one or more preset information channels may be set as the preferred information channels.

The one or more preset information channels may be determined by using any suitable method. For example, the one or more preset information channels may be set by default by the client system. As another example, the one or more preset information channels may be obtained from the server as the information channels that are mostly selected by other users. As yet another example, the one or more preset information channels may be automatically determined by the client system as the information channels that were mostly accessed by the user of the client system.

As shown in FIG. 4, when the channel of “ [symbol] (Headline)” is used as the preset information channel, a touch control corresponding to the channel of “ [symbol] (Headline)” is directly displayed as a selected state in the information channel selection interface. As such, even if the user does not click any touch control, it can be determined that the information channel corresponding to the channel label “ [symbol] (Headline)” is a preferred information channel.

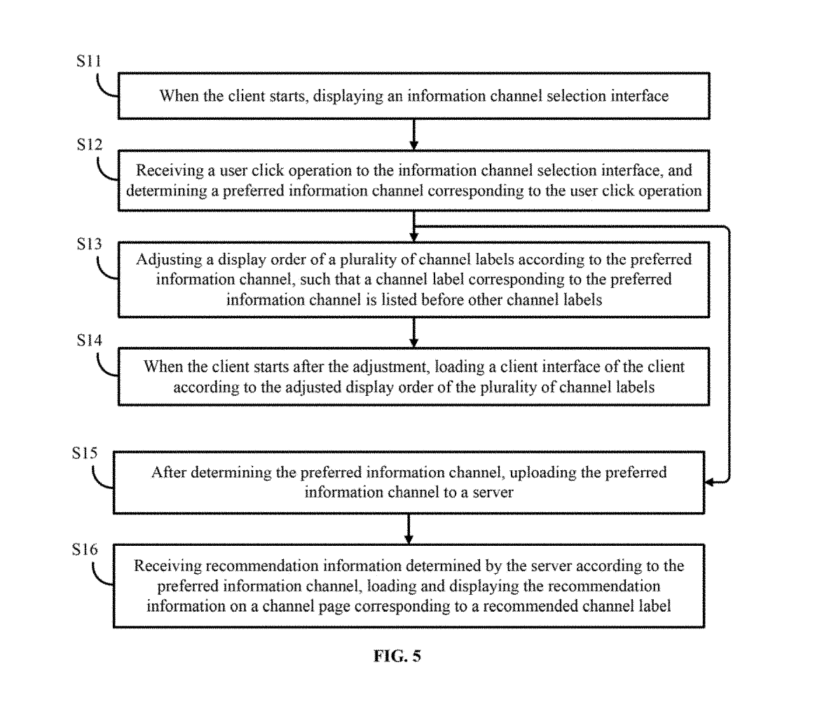

Referring to FIG. 5, a flowchart of another exemplary client interface loading control method is shown in accordance with some other embodiments of the disclosed subject matter. As illustrated, the disclosed client interface loading control method can further include the following steps.

At step S15, after determining the preferred information channels, uploading the preferred information channels to the server.

Specifically, a user identification code (i.e., user ID) corresponding to the client may be uploaded to the server together with the determined preferred information channels. And the server can store the user identification code in association with the preferred information channels.

In some embodiments, the preferred information channel of each user can be stored in the server. As such, if one user does not select a preferred information channel, the information channels that are mostly selected by other users can be sent to the client of the one user as the preference information channels of the one user.

At step S16, the client can receive recommendation information determined by the server according to the preferred information channels, and can load and display the recommendation information on a channel page corresponding to a recommended channel label.

In some embodiments, in addition to the channel labels and the channel pages corresponding to specific type of information, the information reading type client may set a “Recommendation” tab and a recommendation page for centrally displaying the latest information and/or popular information of various types of information. As such, the user can have a comprehensive understanding of the various types of information when the user is browsing the type of information in the user's own interest.

According to step S16, a process for generating and updating the recommendation channel page can specifically include the following sub-steps. When the client is started, or when the client receives a recommendation page update request from the user during the client operation, or when the client arrives at a preset automatic updating time, the client can send a recommendation page update request including at least a recommendation page ID and a user ID to the server. The recommendation page ID can be used for prompting the server to request the updated page as the recommendation channel page, and the user ID can be used for instructing the serve to query and determine the corresponding preferred information channels. The latest information and the popular information corresponding to the preferred information channels can be return to the client in priority. After receiving the recommendation information returned by the server, the client can sequentially load and display the recommendation information on the recommendation channel page.

Accordingly, in some embodiments, the disclosed client interface loading control method can actively display an information channel selection interface when the client is started, and can prompt a user to select the information channels of which the user is most concerned.

Thus, instead of using the channel selection as a general setting function, where a user has to consciously and initiatively find a preset path to enter a channel selection interface to make the select settings, the above approach may mitigate such burden on the user by the general setting function. That is, even if a user does not know the channel selection function or does not know the preset path to enter the channel selection interface, the client may still be able to obtain the preferences of the user, and display different types of information based on the user's preferences according to the user's preference.

In addition, in some embodiments, the disclosed subject matter also provides a computer storage medium, such as a read only memory (ROM), a random access memory (RAM), a CD-ROM, a magnetic tape, a floppy disk, an optical data storage device, etc. A program stored in the computer storage medium for enabling a mobile terminal to perform part or all of the steps of the disclosed client interface loading control method described above can be executed by a hardware processor of the mobile terminal.

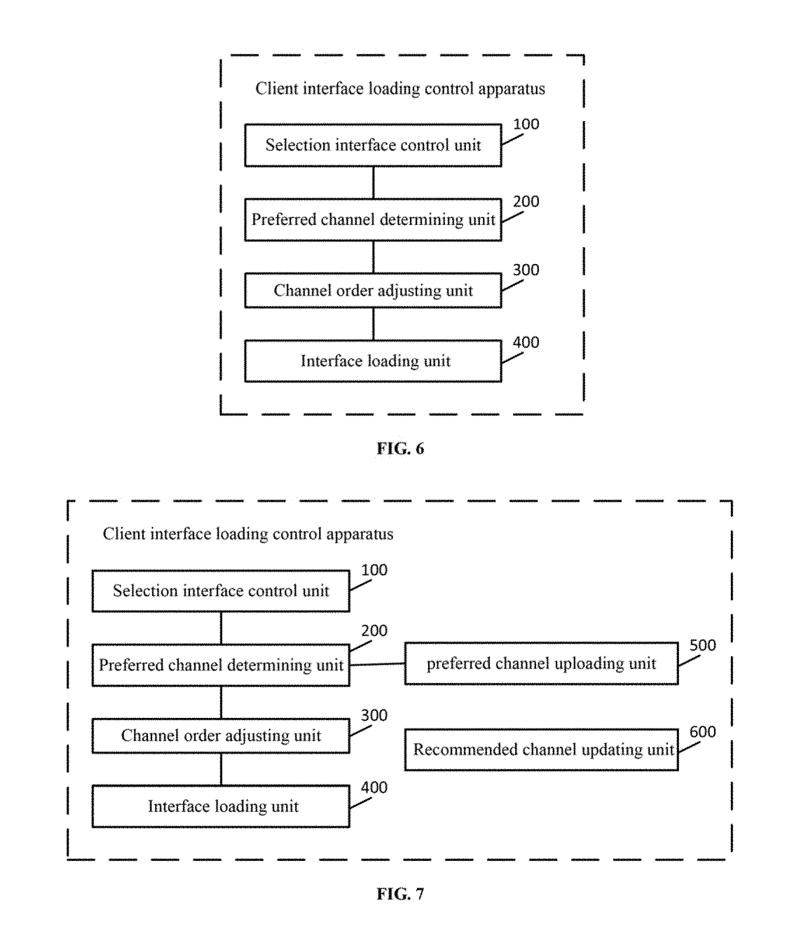

Referring to FIG. 6, a block structural diagram of an exemplary configuration of a client interface loading control apparatus is shown in accordance with some embodiments of the disclosed subject matter.

The apparatus can be applied to a mobile terminal for implementing an interface loading control on a variety of clients having information reading functions running on the mobile terminal. As illustrated, the apparatus can include a selection interface control unit 100, a preferred channel determining unit 200, a channel order adjusting unit 300, and an interface loading unit 400.

The selection interface control unit 100 can be configured for displaying an information channel selection interface when the client is started.

The preferred channel determining unit 200 can be configured for receiving a user click operation to the information channel selection interface, and determining a preferred information channel corresponding to the user click operation.

The channel order adjusting unit 300 can be configured for adjusting die display order of multiple channel labels according to the preferred information channel, so that the channel label of the preferred information channel can be listed before other channel labels.

The interface loading unit 400 can be configured for loading the client interface according to the adjusted display order of the multiple channel labels when the client starts after the adjustment.

According to the above apparatus structure, the disclosed client interface loading control apparatus can display an information channel selection interface to the user when the client starts, and prompt the user to perform click operations to select one or more information channels of interest. The information channels corresponding to user click operations can be determined as the preferred information channels. A display order of channel labels can be adjusted based on the preferred information channels, so that the channel labels corresponding to the preferred information channels can be listed and displayed before other channel labels. As such, after the adjustment of the display order of the channel labels, the client interface can be loaded to display the channel pages of the preferred information channels in priority in the display interface.

Thus, instead of listing the channel labels and the channel pages based on a system default order, the disclosed client interface loading control apparatus can actively guide the user to select the channels of interest, and can move the selected channel forward and display the selected channel in priority. As such, after opening the client, the user can directly see the channel of interest without any manual operations such as dragging and clicking to switch a page of interest o the current page. Therefore, the disclosed client interface loading control apparatus can reduce the manual operation time, and improve the user's experience favorability.

In some embodiments, the above-described selection interface control unit 100 may be specifically configured for displaying the information channel selection interface in the form of bubbles when the client starts. Each bubble in the information channel selection interface can correspond to at least one information channel.

The specific display effect of the information channel selection interface in the form of bubbles can be referred to the description above in connection with FIG. 4.

In some embodiments, the client interface loading control apparatus may further include a preferred channel back-up unit configured for setting one or more preset information channels as the preferred information channels if a user click operation of the information channel selection interface is not received within a predetermined time.

In some scenarios, because a user is not interested in a particular type of information or due to other reasons, the user may not make a selection when the information channel selection interface is displayed on the client. That is, if there is no click operation of the information channel selection interface, the preferred information channel cannot be determined according to the user's taste. By adding the preferred channel back-up unit, one or more preset information channels may be set as the preferred information channels in such scenarios.

Referring to FIG. 7, a block structural diagram of another exemplary configuration of a client interface loading control apparatus is shown in accordance with some other embodiments of the disclosed subject matter. As illustrated, the client interface loading control apparatus may further include a preferred channel uploading unit 500.

The preferred channel uploading unit 500 can be configured for uploading the preferred information channel to the server after determining the preferred information channel.

Further, the client interface loading control apparatus may also include a recommended channel updating unit 600.

The recommended channel updating unit 600 can be configured for receiving recommendation information determined by the server based on the preferred information channel, and for loading and displaying the recommendation information on a channel page corresponding to the recommended channel label.

In some embodiments, the preferred information channel of each user can be uploaded and stored in the server. As such, if one user does not select a preferred information channel, the information channels that are mostly selected by other users can be sent to the client of the one user as the preference information channels of the one user. Additionally, the uploaded information can assist the recommendation channel updating unit to acquire recommendation information in accordance with the preferred information channel of the user.

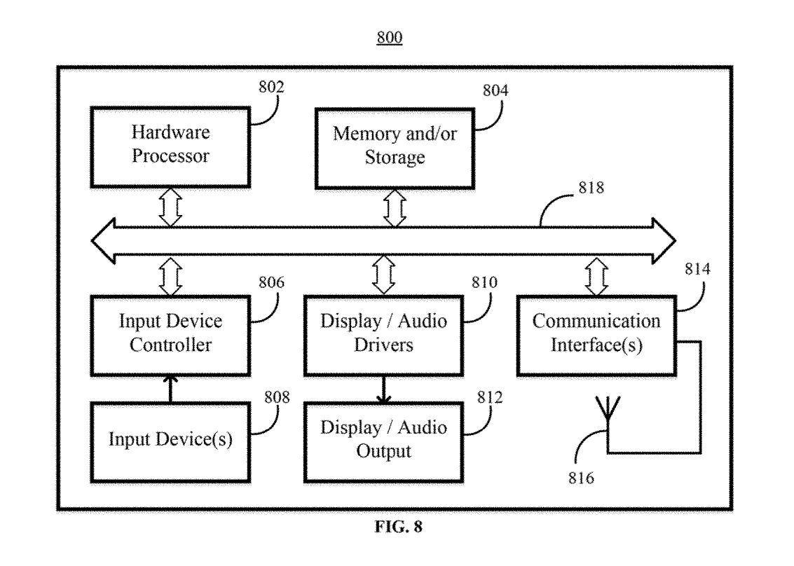

Referring to FIG. 8, a schematic hardware diagram of an exemplary client interface loading control apparatus is shown in accordance with some other embodiments of the disclosed subject matter.

The client interface loading control apparatus 800 cart be included in any suitable device that can communicate with one or more severs though a communication network, receive user request, process and transmit data, and/or present webpages, ands or perform any other suitable function. For example, the client interface loading control apparatus 800 can be a mobile phone, a tablet computer, a laptop computer, a desktop computer, a set-top box, a television, a streaming media player, a game console, and/or any other suitable device.

The hardware of the client interface loading control apparatus 800 can include a hardware processor 802, memory anther storage 804, an input device controller 806, an input device 808, display/audio drivers 810, display and audio output circuitry 812, communication interface(s) 814, an antenna 816, and a bus 818.

Hardware processor 802 can include any suitable hardware processor, such as a microprocessor, a micro-controller, a central processing unit (CPU), a network processor (NP), a digital signal processor (DSP), an application specific integrated circuit (ASIC), a field-programmable gate array (FPGA), or other programmable logic device, discrete gate or transistor logic device, discrete hardware components. The hardware processor 802 can implement or execute various embodiments of the disclosed subject matter including one or more method, steps and logic diagrams. A general purpose processor may be a microprocessor or any other conventional processors.

Memory and/or storage 804 can be any suitable memory and/or storage for storing programs, data, media content, webpage URLs, channel page tables, raw data of webpage resources, information of users and/or any other suitable content in some embodiments. For example, memory and/or storage 804 can include random access memory (RAM), read only memory, flash memory, non-volatile memory, such as hard disk storage, optical media, and/or any other suitable storage device.

Input device controller 806 can be any suitable circuitry for controlling and receiving input from one or more input devices 808 in some embodiments. For example, input device controller 806 can be circuitry for receiving an input from a touch screen, from one or more buttons, from a voice recognition circuit, from a microphone, from a camera, from an optical sensor, from an accelerometer, from a temperature sensor, from a near field sensor, and/or any other suitable circuitry for receiving user input.

Display/audio drivers 810 can be any suitable circuitry for controlling and driving output to one or more display and audio output circuitries 812 in some embodiments. For example, display/audio drivers 810 can be circuitry for driving an LCD display, a speaker, an LED, and/or any other display/audio device.

Communication interface(s) 814 can be any suitable circuitry for interfacing with one or more communication networks, such as a communication network in sonic embodiments. For example, interface(s) 814 can include network interface card circuitry, wireless communication circuitry, and/or any other suitable circuitry for interfacing with one or more communication networks, such as Internet, wide area network, local network, metropolitan area networks, etc.

Antenna 816 can be any suitable ogre or more antennas for wirelessly communicating with a communication network in some embodiments. In some embodiments, antenna 816 can be omitted when not needed.

In some embodiments, the communication network can be any suitable combination of one or more wired and/or wireless networks such as the Internet an intranet, a wide-area network (“WAN”), a local-area network (“LAN”), a wireless network, a digital subscriber line (“DSL”) network, a frame relay network, an asynchronous transfer mode (“ATM”) network, a virtual private network (“VPN”), a WiFi network, a WiMax network, a satellite network, a mobile phone network, a mobile data network, a cable network, a telephone network, a fiber optic network, and/or any other suitable communication network, or any combination of any of such networks.

Bus 818 can be any suitable mechanism for communicating between two or more of components of the webpage resource acquisition apparatus. Bus 818 may be an ISA bus, a PCI bus, an EISA bus, or any other suitable bus. The bus 818 can be divided into an address bus, a data bus, a control bus, etc. The bus 818 is represented as a two-way arrow in FIG. 8, but it does not mean that it is only one type bus or only one bus.

The steps of the disclosed method in various embodiments can be directly executed by a hardware decoding processor, or by a decoding processor combined by a hardware module and a software module. The software module may reside in any suitable storage/memory medium, such as a random access memory, a flash memory, a read-only memory, a programmable read-only memory, an electrically erasable programmable memory, a register, etc. The storage medium can be located in the memory and/or storage 804. Hardware processor 802 can implement the steps of the disclosed method by combining the hardware and the information read from the memory and/or storage 804.

In addition, the flowcharts and block diagrams in the figures illustrate various embodiments of the disclosed method and apparatus, as well as architectures, functions and operations that can be implemented by a computer program product. In this case, each block of the flowcharts or block diagrams may represent a module, a code segment, a portion of program code. Each module, each code segment and each portion of program code can include one or more executable instructions for implementing predetermined logical functions.

It should also be noted that, in some alternative implementations, the functions illustrated in the blocks be executed or performed in any order or sequence not limited to the order and sequence shown and described in the figures. For example, two consecutive blocks may actually be executed substantially simultaneously where appropriate or in parallel to reduce latency and processing times, or even be executed in a reverse order depending on the functionality involved in.

It should also be noted that, each block in the block diagrams and/or flowcharts, as well as the combinations of the blocks in the block diagrams and/or flowcharts, can be realized by a dedicated hardware-based system for executing specific functions, or can be realized by a dedicated system combined by hardware and computer instructions.

Those skilled in the art can clearly understand that, for convenience and simplicity of description, the specific working process of the apparatus and units described above can be referred to the corresponding processes of various embodiments of the disclosed method described above.

Although the disclosed subject matter has been described and illustrated in the foregoing illustrative embodiments, it is understood that the present disclosure has been made only by way of example, and that numerous changes in the details of embodiment of the disclosed subject matter can be made without departing from the spirit and scope of the disclosed subject matter, which is dryly limited by the claims which follow. Features of the disclosed embodiments can be combined and rearranged in various ways. Without departing from the spirit and scope of the disclosed subject matter, modifications, equivalents, or improvements to the disclosed subject matter are understandable to those skilled in the an and are intended to be encompassed within the scope of the present disclosure. It should be noted that, similar reference numerals and letters are refer to similar items in the figures, and thus once an item is defined in one figure, it can be no father defined and explained in the subsequent figures.

What is claimed is:

1. A method for controlling an interface loading of a client, comprising:
when the client starts, displaying an information channel selection interface;
receiving a user click operation to the information channel selection interface, and determining a preferred information channel corresponding to the user click operation;
adjusting a display order of a plurality of channel labels according to the preferred information channel, such that a channel label corresponding to the preferred information channel is listed before other channel labels; and
when the client starts after the display order is adjusted, loading a client interface of the client according to the adjusted display order of the plurality of channel labels.

2. The method of claim 1, wherein:
the information channel selection interface is displayed in a form of bubbles; and
each bubble of the information channel selection interface corresponds to at least one information channel.

3. The method of claim 1, further comprising:
if a user click operation of the information channel selection interface is not received within a predetermined time, setting at least one preset information channel as the preferred information channel.

4. The method further comprising:
displaying a page switching control in the information channel selection interface.

5. The method of claim 1, further comprising:
after determining the preferred information channel, uploading the preferred information channel to a server.

6. The method of claim 5, wherein:
the preferred information channel is uploaded in association with a user ID of the client.

7. The method of claim 5, further comprising:
receiving recommendation information determined by the server according to the preferred information channel; and
loading and displaying the recommendation information on a channel page corresponding to a recommended channel label.

8. The method of claim 3, wherein:
the at least one preset information channel is determined by the client based on n information channel accessing history of the client.

9. The method of claim 3, wherein:
the at least one preset info oration channel is determined by a serve based on statistic information channel accessing data of a plurality of users.

10. The method of claim 1, further comprising:
determining a first preferred information channel corresponding to a first user click operation to the information channel selection interface;
determining a second preferred information channel corresponding to a second user click operation to the information channel selection interlace; and
adjusting a display order of a plurality of channel labels, such that a first channel label corresponding to the first preferred information channel and a second channel label corresponding to the second preferred information channel are listed before other channel labels.

11. The method of claim 10, wherein:
adjusting the display order of the plurality of channel labels includes ranking the first channel label and the second channel label based on a clicking order of the first user click operation and the second user click operation.

12. The method of claim 10, wherein:
adjusting the display order of the plurality of channel labels includes ranking the first channel label and the second channel label based on a system default channel label order.

13. An apparatus for controlling an interface loading of a client, comprising:
a selection interface control unit configured for displaying an information channel selection interface when the client starts;
a preferred channel determining unit configured for receiving a user click operation to the information channel selection interface, and determining a preferred information channel corresponding to the user click operation;
a channel order adjusting unit configured for adjusting a display order of a plurality of channel labels according to the preferred information channel, such that a channel label corresponding to the preferred information channel is listed before other channel labels; and
an interface loading unit configured for loading a client interface of the client according to the adjusted display order of the plurality of channel labels when the client starts after the display order is adjusted.

14. The apparatus of claim 13, wherein the selection interface control unit is further configured for:
displaying the information channel selection interface in a form of bubbles;
wherein each bubble of the information channel selection interface corresponds to at least one information channel.

15. The apparatus of claim 13, further comprising:
a preferred channel back-up unit configured for setting at least one preset information channel as the preferred information channel if a user click operation of the information channel selection interface is not received within a predetermined time.

16. The apparatus of claim 13, wherein the selection interface control unit is further configured for:
displaying a page switching control in the information channel selection interface.

17. The apparatus of claim 13, further comprising:
a preferred channel uploading unit configured for uploading the preferred information channel to a server after determining the preferred information channel.

18. The apparatus of claim 17, further comprising a recommended channel updating unit configured for:
receiving recommendation information determined by the server according to the preferred information channel; and
loading and displaying the recommendation information on a channel page corresponding to a recommended channel label.

19. The apparatus of claim 15, wherein:
the at least one preset information channel is determined by the client erased ctrl an information channel accessing history of the client.

70. The apparatus of claim 15, wherein:
the at least one preset information channel is determined by a serve based on statistic information channel accessing data of a plurality of users.
